(19) United States
(12) Patent Application Publication
(10) Pub. No.: US 2016/0217412 A1
(43) Pub. Date: Jul. 28, 2016

(54) PEOPLE QUEUE OPTIMIZATION AND COORDINATION

(71) Applicant: International Business Machines Corporation, Armonk, NY (US)

(72) Inventors: Emmanuel Barajas Gonzalez, Guadalajara (MX); Shaun E. Harrington, Sahuarita, AZ (US); David C. Reed, Tucson, AZ (US); Max D. Smith, Tucson, AZ (US)

(73) Assignee: International Business Machines Corporation, Armonk, NY (US)

(21) Appl. No.: 14/608,106

(22) Filed: Jan. 28, 2015

(51) Int. Cl. G06Q 10/06

(52) U.S. Cl. CPC G06Q 10/063114

(57) ABSTRACT

A method for optimizing and coordinating people queues is disclosed. In one embodiment, such a method includes determining a set of tasks desired to be performed by a user. This may include determining a set of establishments needed to perform such tasks. The method further includes querying at least one queueing system to determine wait times associated with performing the tasks. Based on the wait times, the method automatically determines an optimized schedule for performing the set of tasks. In certain embodiments, determining an optimized schedule may include determining a shortest time for performing the set of tasks. A corresponding system and computer program product are also disclosed.

### BACKGROUND

1. Field of the Invention

This invention relates to systems and methods for optimizing the use of and coordination of people queues.

2. Background of the Invention

Over the last decade, the utility and capability of smart phones and other mobile computing devices has increased dramatically. At the time of this writing, more than 1.5 billion smart phones are in service. Improved and expanded functionality, such as WiFi, Bluetooth, GPRS (General Packet Radio Service), GPS (Global Positioning System) functionality, and the like, has allowed smart phones and other mobile computing devices to receive and generate content in ways previously reserved to personal computing. The growth of the smart phone market has prompted existing corporations and startups to vie for a piece of the market, such as by producing mobile operating systems, or by extending a device's core capabilities with applications (i.e., “apps”). Such applications are often driven by customer demand and may be used in tandem with the functionality described above to manage common needs and situations in a smarter way. While many common situations are addressed by such “apps,” others needs and situations are either not addressed or not adequately addressed.

When entering an establishment such as a private business, government office, or the like, it is typical to enter with the expectation of waiting some amount of time prior to receiving service. Although managing waiting customers has been handled in various ways, the most common way is to form a line originating at the source of a desired service. The customer must generally wait in this line until reaching the source. Other approaches have been implemented, such as taking a number and proceeding to a service provider when the number is called. Other similar approaches include receiving and waiting for notifications on a paging device, or watching a display (e.g., television) containing a list of individuals in a virtual line until a name is selected or highlighted. Such techniques are generally time consuming and result in significant wasted time not only for the waiting customer but also for employees that have to manage such systems.

In view of the foregoing, what are needed are systems and methods to more optimally manage people queues, both for people in the queues as well as those managing the queues. Ideally, such systems and methods will save time and reduce inefficiencies for those using and managing such queues. Yet further needed are systems and methods for coordinating the use of people queues of multiple establishments. Yet further needed are systems and methods to maintain the integrity and reliability of people queues.

### SUMMARY

The invention has been developed in response to the present state of the art and, in particular, in response to the problems and needs in the art that have not yet been fully solved by currently available systems and methods. Accordingly, systems and methods are disclosed to optimize and coordinate people queues. The features and advantages of the invention will become more fully apparent from the following description and appended claims, or may be learned by practice of the invention as set forth hereinafter.

Consistent with the foregoing, a method for optimizing and coordinating people queues is disclosed. In one embodiment, such a method includes determining a set of tasks desired to be performed by a user. This may include determining a set of establishments needed to perform such tasks. The method further includes querying at least one queueing system to determine wait times associated with performing the tasks. Based on the wait times, the method automatically determines an optimized schedule for performing the set of tasks. In certain embodiments, determining an optimized schedule may include determining a shortest time for performing the set of tasks.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a computing system in which a system and method in accordance with the invention may be implemented;

FIG. 2 is a high-level block diagram showing one technique for adding a customer to a people queue (e.g., wait list) of an establishment;

FIG. 3 is a high-level block diagram showing a first example of coordinating people queues of multiple establishments;

FIG. 4 is a high-level block diagram showing a second example of coordinating people queues of multiple establishments;

FIG. 5 is a high-level block diagram showing a third example of coordinating people queues of multiple establishments;

FIG. 6 is a flow diagram showing one embodiment of a method for adding a customer to a people queue (e.g., wait list) of an establishment;

FIG. 7 is a flow diagram showing one embodiment of a method for maintaining integrity and reliability of a people queue, particularly by enforcing travel and/or location restrictions; and

FIG. 8 is a flow diagram showing one embodiment of a method for creating an optimized schedule that coordinates people queues of multiple establishments.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

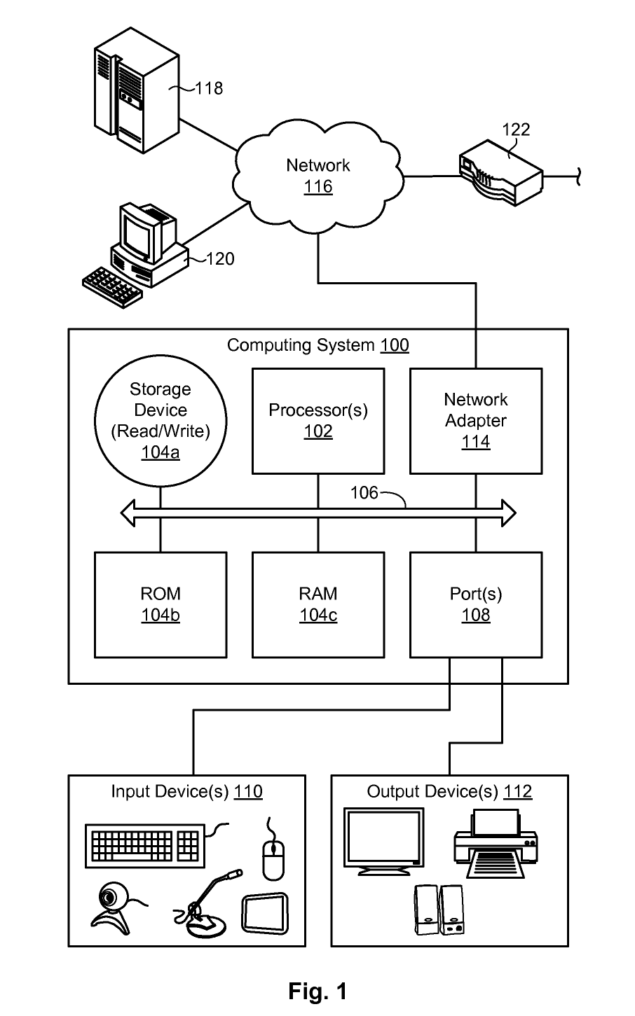

Referring to FIG. 1, one example of a computing system 100 is illustrated. The computing system 100 is presented to show one example of an environment where a system and method in accordance with the invention may be implemented. The computing system 100 may be embodied as a mobile device 100 such as a smart phone or tablet, a desktop computer, a workstation, a server, or the like. The computing system 100 is presented only by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a network adapter 114 to connect the computing system 100 to a network 116, such as a LAN, WAN, or the Internet. Such a network 116 may enable the computing system 100 to connect to one or more servers 118, workstations 120, personal computers 120, mobile computing devices, or other devices. The network 116 may also enable the computing system 100 to connect to another network by way of a router 122 or other device 122. Such a router 122 may allow the computing system 100 to communicate with servers, workstations, personal computers, or other devices located on different networks.

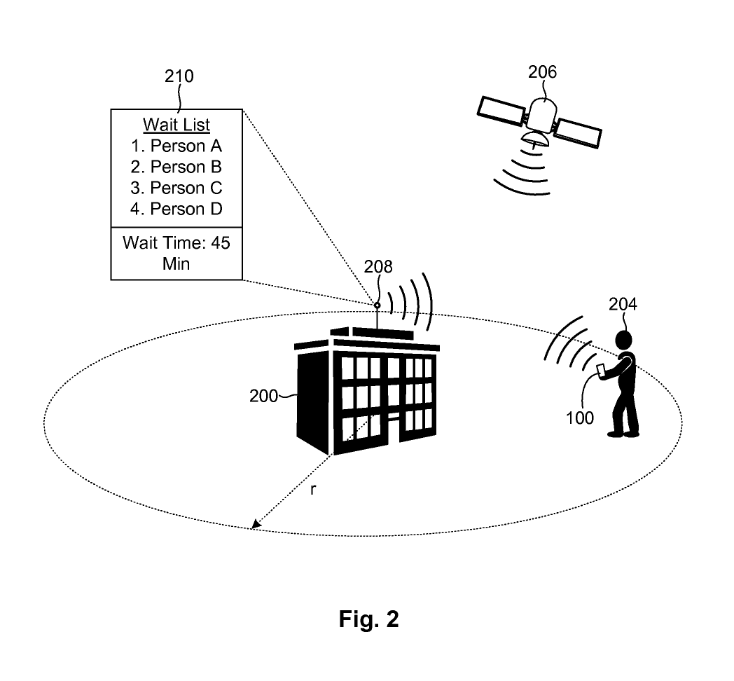

Referring to FIG. 2, as previously mentioned, when entering an establishment such as a private business, government office, or the like, it is typical to enter with the expectation of waiting some amount of time prior to receiving service. For example, at a restaurant, a customer may need to wait some amount of time prior to receiving a table. At a retailer, a customer may need to wait in line to purchase a product. To get an oil change, a customer may need to wait for his or her turn at a service station to receive service. Similarly, at a government office such as the Department of Motor Vehicles (DMV), a customer may need to take a number and wait in a designated waiting area prior to receiving service. These are non-limiting examples of situations where a customer may have to wait to receive service. As previously mentioned, waiting to receive service is time consuming and results in significant wasted time not only for the waiting customer but also for employees that have to manage queues or waiting lists. Thus, systems and methods are needed to more optimally manage people queues, both for people in the queues as well as those managing the queues. For the purposes of this disclosure, the term “queue” and phrase “people queue” are broadly used herein to describe wait lists, lines, or other mechanisms used to provide time-delayed and orderly service to people.

FIG. 2 is a high-level block diagram showing an efficient technique for adding a customer 204 to a people queue 210 (e.g., wait list) of an establishment 200. This technique assumes that a customer 204 has or is carrying a mobile device 100, such as a smart phone 100 or tablet 100, comprising specialized hardware and/or software to facilitate the functionality described herein. In this example, functionality detects when a customer 204 nears or enters an establishment 200. In one embodiment, this is accomplished by the customer's mobile device 100 and/or or an application on the customer's mobile device 100. In certain embodiments, the mobile device 100 may accomplish this by comparing its current position (using GPS coordinates from a satellite 206 or other location data) with a know location of the establishment 200. When the mobile device 100 is within a specified area, such as within a specified radius (r) around the establishment 200, the mobile device 100 may be deemed to be at or near the establishment 200. Alternatively, the mobile device 100 or an application on the mobile device 100 may be activated when it comes within communication range of a local network 208 (e.g., LAN 208) of the establishment 200.

When the mobile device 100 is at or near the establishment 200, a customer 204 may be added to a queue 210 (e.g., wait list) of the establishment 200. In certain embodiments, this occurs automatically without intervention of the customer 204. In other embodiments, the customer 204 may be prompted whether he or she wants to be added to the queue 210 and the customer 204 may authorize such on the mobile device 100. Once added to the queue 210, the customer 204 may have a reserved spot in line to receive the services offered by the establishment 200. In certain embodiments, this may be accomplished prior to actually entering or interacting with employees at the establishment 200. As can be appreciated by those of skill in the art, an establishment's queue 210 and/or queueing system may be hosted on a server on site at the establishment 200 or remotely at a location removed from the establishment 200.

In certain embodiments, the customer 204 may optionally provide information to the establishment 200 (by way of the mobile device 100) when he or she is added to the establishment's queue 210. This may be as simple as providing a name and/or other identifying information to the establishment 200. In other embodiments, more detailed or pertinent information may be provided. For example, if the customer is visiting a restaurant, the customer 204 may provide information such as the number of people in the party, a desired time to be seated, or the like. If the customer is visiting the DMV, the customer 204 may provide information (e.g., customer address, vehicle information, reason for visit, etc.) needed to service the customer 204. This information may be provided to the establishment 200 automatically or at the prompting of the customer 204.

In certain embodiments, functionality may be provided to maintain integrity and reliability of an establishment's queueing system. For example, if a customer 204 is registered on a queueing system but then decides to leave prior to receiving service, the establishment's queue 210 may not accurately reflect the number of persons waiting and/or the wait time to receive service. In some cases, queues 210 may be abused in that some people may sign themselves up on the queues 210 of multiple establishments 200 only to show up at a single establishment 200 or a smaller number of establishments 200 depending on what is most convenient. Such activities may increase the inaccuracy and/or unpredictability of an establishment's queueing system. Thus, systems and methods are needed to ensure that an establishment's queue 210 is substantially accurate and reflects people actually on the list and intending to receive service.

For example, in certain embodiments, a mobile device's location may be monitored to determine whether a customer 204 is within a certain distance of an establishment 200. The customer's distance from the establishment 200 may be a good indicator of whether the customer 204 is actually in line and intending to receive service. The customer's distance from the establishment 200 may also indicate if the customer 204 can arrive at the establishment 200 in time for his or her turn in the queue 210. If the customer 204 is not going to be present or cannot feasibly arrive in time to receive service, the queue 210 may be updated by either removing the customer 204 or modifying the customer's position within the queue 210.

In certain embodiments, a circle having radius (r) or other area may be defined for an establishment 200. A customer's presence within this radius may be used to affect his or her registration in the queue 210. While the customer 204 is inside the radius, the customer 204 may remain in the queue 210. When the customer 204 travels outside of the radius, the customer 204 may be removed from the queue 210 or notified that he or she must move back inside the radius to remain in the queue 210. Alternatively, or additionally, the customer's position with respect to the radius may be monitored depending on the customer's time left in the queue 210. For example, the customer 204 may be required to be inside the radius when the customer's turn is approaching, such as when the customer's wait time in the queue 210 is ten minutes or less. In certain embodiments, if the customer 204 is outside of this radius and the customer's turn is approaching, the customer 204 may be notified that he or she must move inside the radius to remain in the queue 210. This will ensure that the queue 210 accurately reflects actual waiting customers and that a customer 204 is likely to be present when it is his or her turn to receive service.

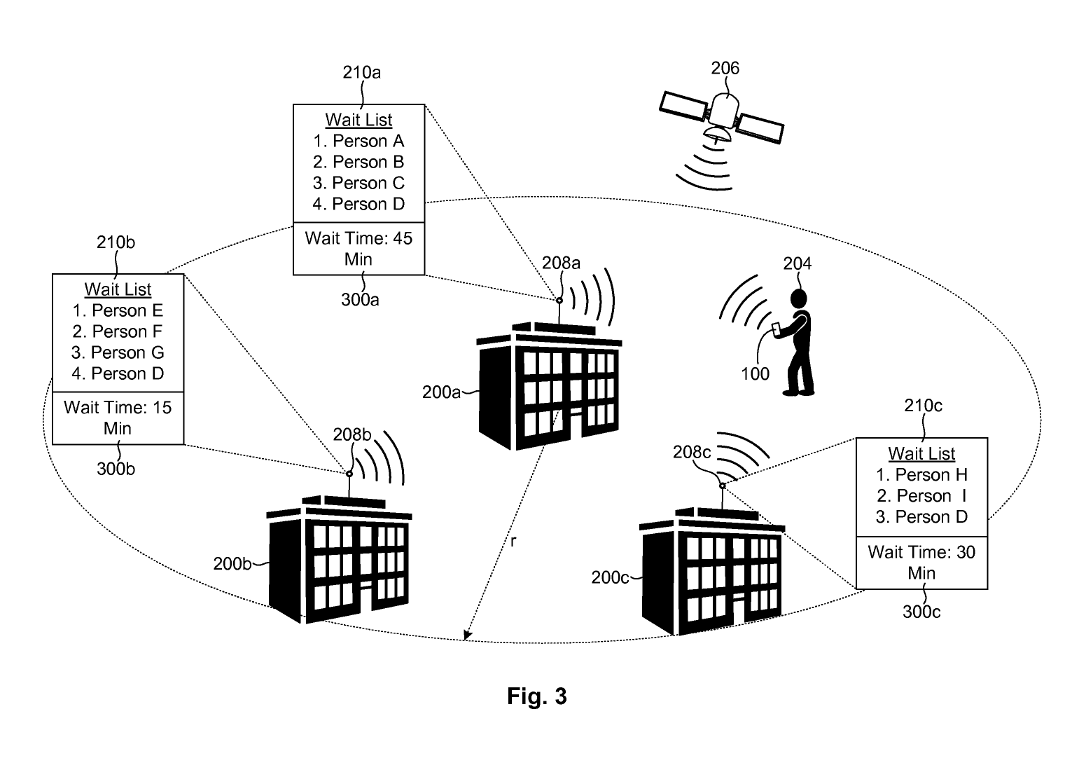

Referring to FIG. 3, in certain cases, a mobile device 100 and/or an application operating on a mobile device 100 may assist in optimizing a schedule to visit multiple establishments 200. For example, systems and methods in accordance with the invention may enable a user to specify multiple tasks that he or she wants to perform. This may include specifying actions (e.g., dry cleaning, oil change, haircut, vehicle registration, eat lunch, etc.) the user wants to perform and/or establishments 200 the user wants to visit. If actions are specified, systems and methods in accordance with the invention may suggest or determine establishments 200 (e.g., specific dry cleaners, car maintenance service stations, barbers, DMV, restaurants, etc.) that may be helpful or needed to accomplish these actions. In certain cases, establishments 200 may be identified that are near the user's location. In other cases, an initial establishment 200 may be identified to perform a particular task and other establishments 200 near this initial establishment 200 may be identified to perform other desired tasks.

Once establishments 200 needed to perform the tasks have been identified, systems and methods in accordance with the invention may query queueing systems (hosted in remote or local servers) of the establishments 200 to determine wait times 300a-c in their respective queues 210a-c. Based on these wait times, an optimized schedule may be generated. For example, based on the wait times illustrated in FIG. 3, a customer 104 may initially visit establishment 200b (15 minute wait time), then establishment 200c (30 minute wait time), and then establishment 200a (45 minute wait time), assuming the customer 204 can complete each visit and proceed to the next establishment 200 in fifteen minutes or less. Such functionality may enable a user to make more efficient use of time that would otherwise be spent waiting in the line of a single establishment 200.

In certain embodiments, systems and methods in accordance with the invention may find establishments 200b, 200c that are within a specified radius of another establishment 200a. For example, if a customer 204 needs to be at a certain establishment 200a to complete a specified task, other establishments 200b, 200c with shorter wait times 300b, 300c may be identified to perform other desired tasks while the customer 204 is waiting to receive service at the certain establishment 200a. In certain embodiments, establishments 200 will be chosen that are within the radius (r) of the establishment 200a so as not to cause the customer 204 to travel outside of the radius and possibly be removed from the establishment's queue 210a. Thus, in certain embodiments, systems and methods in accordance with the invention may consider the location of an establishment 200 and potential travel or location restrictions when locating other establishments 200 to perform desired tasks.

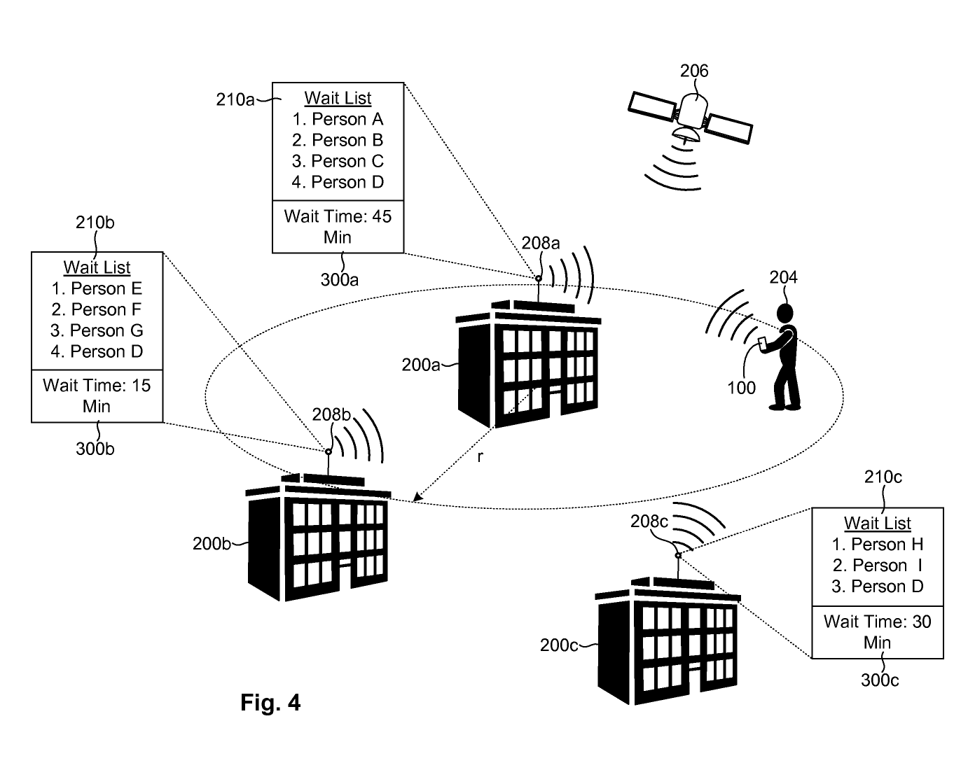

Referring to FIG. 4, in other embodiments, systems and methods in accordance with the invention may enable a customer 204 to travel outside of a specified radius (r) of an establishment 200a as long as the customer 204 can return to the establishment 200a by the time it is his or her turn and not violate restrictions that would cause him or her to be removed from the establishment's queue 210a. For example, if an establishment 200 requires that a customer 204 be within a specified radius (r) within five minutes of his or her turn, an optimized schedule may include visits to establishments 200b, 200c outside of the radius as long as these visits can be completed in time to allow the customer 204 to return and enter the radius within five minutes of his or her turn. In other cases, a customer 204 may only be allowed to exit the radius for a specified amount of time prior to being removed from the queue 210a. In such cases, the optimized schedule may allow a customer 204 to exit the radius to perform other tasks as long as the customer 204 can perform these tasks and return and enter the radius in the specified amount of time.

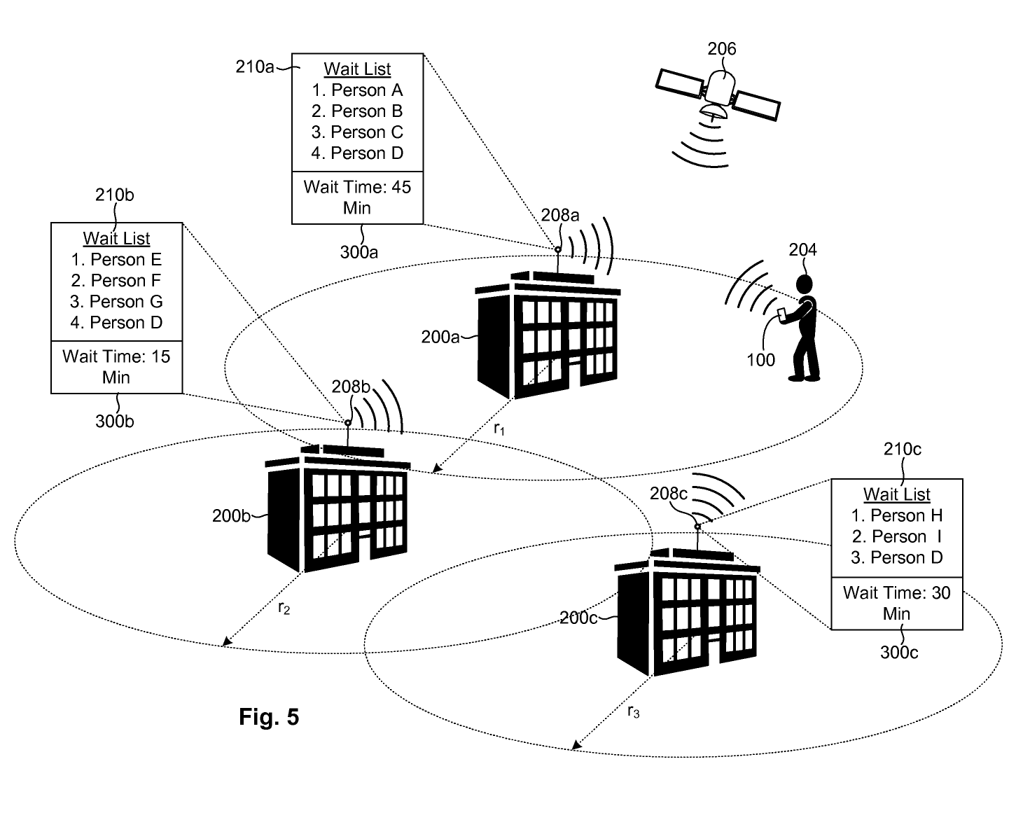

Referring to FIG. 5, in yet other embodiments, systems and methods in accordance with the invention may take into account travel or location restrictions of multiple establishments 200 when generating an optimized schedule. For example, assume that a customer 204 wishes or needs to visit establishments 200a-c to perform various tasks. Each of these establishments 200 may have their own travel or location restrictions that need to be obeyed to remain on the establishments' queues 210a-c. For example, each of these establishments 200a-c may have radii (r₁, r₂, r₃) that define how far away a customer 204 can travel or be located to remain in the establishments' queues 210a-c. These restrictions may limit the amount of time a customer 204 can reside outside a radius prior to being removed from a queue 210 and/or limit how much time prior to an appointment or turn the customer 204 may reside outside the radius. Systems and methods in accordance with the invention make take these restrictions into account when designing an optimized schedule. More specifically, systems and methods in accordance with the invention may design an optimized schedule that enables a customer 204 to be on multiple queues 210 without violating travel or location restrictions or creating other situations where the customer 204 will be undesirably removed from one or more queues 210.

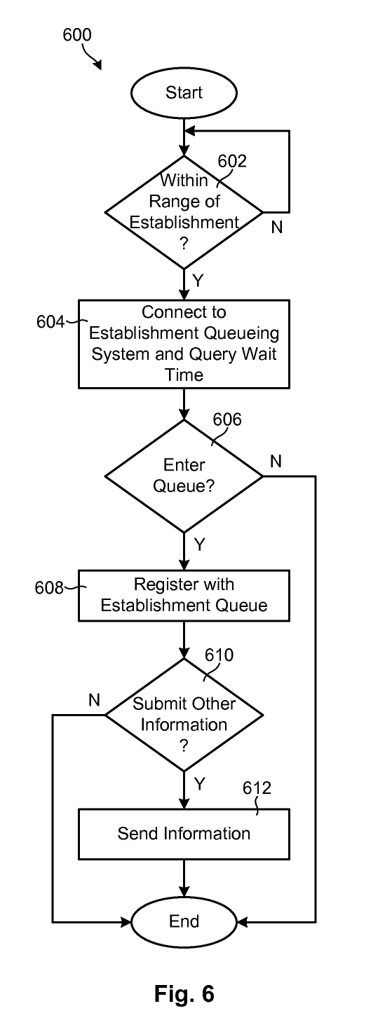

Referring to FIG. 6, one embodiment of a method 600 for adding a customer 204 to a people queue 210 (e.g., wait list) is illustrated. Such a method 600 was generally discussed in association with FIG. 2 and may, in certain embodiments, be at least partly executed by a customer's mobile device 100 and/or an application on the customer's mobile device 100. As shown, the method 600 includes initially determining 602 whether a customer's mobile device 100 is within range of an establishment 200. This may include determining 602 if the mobile device 100 is within a specified area, such as within a specified radius (r) of the establishment 200. Alternatively, this may include determining 602 whether the mobile device 100 is within communication range of a local network 208 (e.g., LAN) of the establishment 200.

If the mobile device 100 is within range of the establishment 200, the method 600 connects the mobile device 100 to the establishment's queueing system and queries the wait time associated with the queueing system. At this point, the customer 204 may opt to enter 606 the establishment's queue 210. Alternatively, the customer 204 may be automatically placed in the queue 210 when he or she is in the specified range of the establishment 200. If the customer 204 opts to enter 606 the queue 210 or is automatically added to the queue 210, the method 600 registers 608 the customer 204 with the establishment's queue 210. If the customer 204 does not wish to enter the queue 210, the method 600 ends.

If the customer 204 opts to enter the queue 210, the method 600 determines 610 whether the queueing system accepts or requires additional information. For example, the queueing system may request information such as a customer's name, address, phone number, email address, or the like. If the customer is visiting a restaurant, the queueing system may require information such as a number of people in a party, a desired time to be seated, or the like. In other cases, information such as a reason for a visit may be required or desired to enable an establishment 200 to best serve a customer 204. If other information is desired or required at step 610 and the customer 204 agrees to provide such information, the method 600 sends 612 the information to the queueing system.

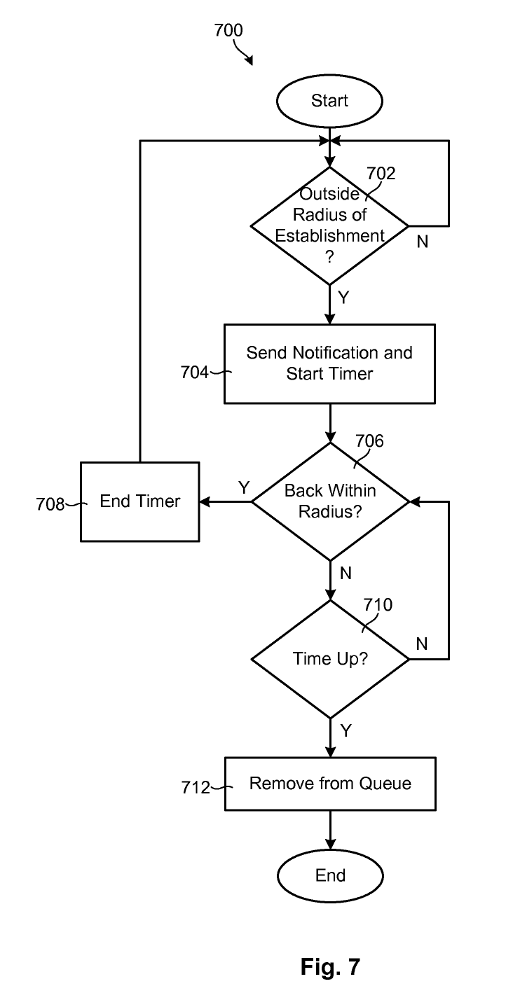

Referring to FIG. 7, one embodiment of a method 700 for maintaining integrity and reliability of a people queue 210, particularly by enforcing travel and/or location restrictions, is illustrated. This method 700 is provided by way of example and not limitation. As shown, once a customer 204 is registered in an establishment's queue 210, the method 700 determines 702 whether the customer 204 is outside a radius associated with the establishment 200. If the customer 204 is not outside the radius, the method 700 restarts and continues to monitor 702 the location of the customer 204 relative to the radius. If the customer 204 is outside the radius, the method 700 sends 704 a notification to the customer 204, such as a notification informing the customer 204 that he or she will be removed from the queue 210 if he or she does not move back inside the radius within a specified amount of time. In this embodiment, the method 700 starts 704 a timer upon sending 704 the notification.

Once the timer is running, the method 700 continually monitors 706 whether the customer 204 has moved back inside the radius. If the customer 204 has moved back inside the radius the timer may be terminated 708 and flow may pass back to the top of the method 700. If the customer 204 has not moved back inside the radius, the method 700 checks 710 whether the customer's time is up. If the customer's time is not up, the method 700 continues to monitor 706 whether the customer 204 has moved back inside the radius. If, on the other hand, the customer's time is up and the customer 204 has not moved back inside the radius, the method 700 removes 712 the customer 204 from the queue 210 and the method 700 ends.

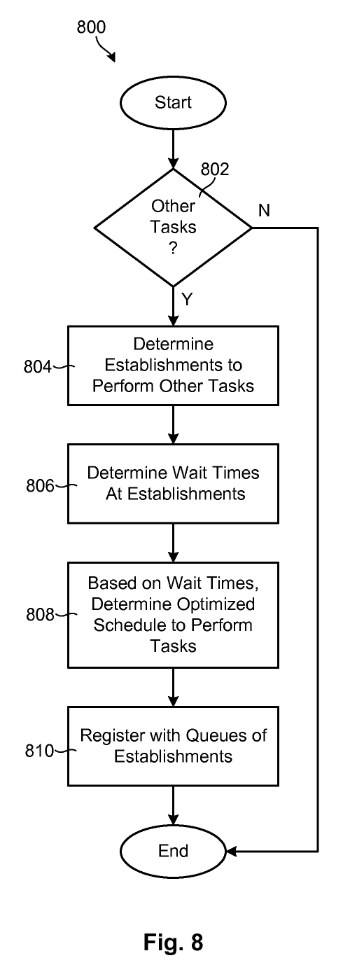

Referring to FIG. 8, one embodiment of a method 800 for creating an optimized schedule that coordinates people queues 210 of multiple establishments 200 is illustrated. As shown, once a customer 204 is registered in a queue 210 (e.g., on the wait list 210) of an initial establishment 200, the method 800 determines 802 whether the customer 204 has any other tasks that he or she wants to perform. If not, the method 800 ends. If so, the method 800 determines 804 which establishments may be used to perform these tasks. In certain embodiments, these establishments 200 are those closest to the initial establishment 200 and/or those with the shortest wait times that are reasonably close to the initial establishment 200. The method 800 then determines 806 the wait times for these establishments 200. Based on the wait times, the method 800 determines 808 an optimized schedule to visit the establishments 200 and perform the tasks. In certain embodiments, determining 808 an optimized schedule includes determining a shortest time for performing the set of tasks, which in turn may include determining an order and/or timing in which to visit the various establishments 200 and perform the desired tasks. The method 800 may optionally register 810 the customer 204 in queues 210 of establishments 200 that are part of the optimized schedule. Once the optimized schedule is created, the method 800 ends.

Other variations and additions to the disclosed systems and methods are possible and within the scope of the invention. For example, in addition to assisting customers 204 register with establishment queues 210, the disclosed systems and methods may be configured to locate coupons or deals to aid the customer 204 in deciding which establishments 200 to visit, or to help the customer 204 save money at establishments 200 that are part of an optimized schedule. In other embodiments, inventory information may be made available to the customer 204. This may enable a customer 204 to schedule and plan visits to establishments 200 when and where desired inventory is available or becomes available. In yet other embodiments, when a customer 204 registers with an establishment's queue 210, functionality may be provided to enable content such as advertisements, videos, and other content to be streamed or otherwise provided to the customer's mobile device 100 while the customer 204 is waiting in the queue 210.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method comprising:
determining a set of tasks desired to be performed by a user;
querying at least one queueing system to determine wait times associated with performing the tasks; and
based on the wait times, automatically determining an optimized schedule for performing the set of tasks.

2. The method of claim 1, wherein determining a set of tasks comprises determining a set of establishments needed to perform the desired tasks.

3. The method of claim 2, wherein determining the set of establishments comprises determining the set of establishments based on a location of the user.

4. The method of claim 1, wherein determining an optimized schedule comprises determining a shortest time for performing the set of tasks.

5. The method of claim 1, further comprising enabling the user to register with the at least one queueing system in order to perform the set of tasks in accordance with the optimized schedule.

6. The method of claim 5, further comprising deregistering the user with the at least one queueing system in the event the user is outside a specified radius of an establishment associated with the at least one queueing system.

7. The method of claim 6, further comprising deregistering the user in the event the user is outside the specified radius for a specified amount of time.

8. A computer program product comprising a computer-readable storage medium having computer-usable program code embodied therein, the computer-usable program code comprising:
computer-usable program code to determine a set of tasks desired to be performed by a user;
computer-usable program code to query at least one queueing system to determine wait times associated with performing the tasks; and
computer-usable program code to, based on the wait times, automatically determine an optimized schedule for performing the set of tasks.

9. The computer program product of claim 8, wherein determining a set of tasks comprises determining a set of establishments needed to perform the desired tasks.

10. The computer program product of claim 9, wherein determining the set of establishments comprises determining the set of establishments based on a location of the user.

11. The computer program product of claim 8, wherein determining an optimized schedule comprises determining a shortest time for performing the set of tasks.

12. The computer program product of claim 8, further comprising computer-usable program code to enable the user to register with the at least one queueing system in order to perform the set of tasks in accordance with the optimized schedule.

13. The computer program product of claim 12, further comprising computer-usable program code to deregister the user with the at least one queueing system in the event the user is outside a specified radius of an establishment associated with the at least one queueing system.

14. The computer program product of claim 13, further comprising computer-usable program code to deregister the user in the event the user is outside the specified radius for a specified amount of time.

15. A system comprising:
at least one processor;
at least one memory device coupled to the at least one processor and storing instructions for execution on the at least one processor, the instructions causing the at least one processor to:
determine a set of tasks desired to be performed by a user;
query at least one queueing system to determine wait times associated with performing the tasks; and
based on the wait times, automatically determine an optimized schedule for performing the set of tasks.

16. The system of claim 15, wherein determining a set of tasks comprises determining a set of establishments needed to perform the desired tasks.

17. The system of claim 16, wherein determining the set of establishments comprises determining the set of establishments based on a location of the user.

18. The system of claim 15, wherein determining an optimized schedule comprises determining a shortest time for performing the set of tasks.

19. The system of claim 15, wherein the instructions further cause the at least one processor to register the user with the at least one queueing system in order to perform the set of tasks in accordance with the optimized schedule.

20. The system of claim 19, wherein the instructions further cause the at least one processor to deregister the user with the at least one queueing system in the event the user is outside a specified radius of an establishment associated with the at least one queueing system.
